(19) United States
(12) Patent Application Publication
(10) Pub. No.: US 2008/0040089 A1
(43) Pub. Date: Feb. 14, 2008

(54) Efficient Characterization of High-Speed Circuits

(76) Inventors: Wendemagagnehu Beyene, San Jose, CA (US); Xiagchao Yuan, Palo Alto, CA (US)

Correspondence Address: MORGAN LEWIS & BOCKIUS LLP/RAMBUS INC., 2 PALO ALTO SQUARE, 3000 EL CAMINO REAL, PALO ALTO, CA, 94306, US

(21) Appl. No.: 11/458,380

(22) Filed: Jul. 18, 2006

(51) Int. Cl. G06F 17/50

(52) U.S. Cl. 703/14

(57) ABSTRACT

Input parameters for a circuit that is to be characterized are provided. A characteristic of the circuit is determined. A simulated output parameter of the circuit is determined using a supervised learning algorithm in accordance with the characteristic and at least two of the input parameters. A first pass/fail criterion is determined in accordance with the simulated output parameter.

### FIELD

The subject matter disclosed herein relates generally to techniques for characterizing of circuits, and in particular, to methods and associated programs and devices for determining characteristics of circuits using supervised learning techniques.

### BACKGROUND

Characterization and qualification testing of integrated circuits is often complicated and time consuming, especially when circuits are tested at high speeds over a wide range of environmental and operating conditions, such as functional and electrical conditions. As a consequence, many existing approaches to characterizing integrated circuits utilize simplified test sequences to reduce the cost of test equipment, test time, and/or the cost of manufacturing the integrated circuits.

These approaches, however, may not accurately and exhaustively characterize the integrated circuits. For example, limited measurements may not produce results that are representative of the statistical impact of process variations in production. Furthermore, existing techniques for mapping parameter measurements to circuit performance, such as from a mean-square error or the signal-to-noise ratio to the bit-error rate, are often challenging. The tradeoff between accuracy and efficiency in testing, therefore, may have consequences for device yield and robustness.

There is a need, therefore, for improved techniques for characterizing integrated circuits.

### BRIEF DESCRIPTION OF THE DRAWINGS

For a better understanding, reference should be made to the following detailed description taken in conjunction with the accompanying drawings, in which:

FIG. 1 is a block diagram illustrating an embodiment of modeling of a device.

FIG. 2 is a block diagram illustrating a neural network model.

FIG. 3 is a flow diagram illustrating an embodiment of a method for characterizing a circuit.

FIG. 4 is a graph that illustrates error as a function of model training.

FIG. 5 is a block diagram illustrating an embodiment of orthogonal arrays.

FIG. 6 is a timing diagram illustrating timing parameters with respect to a data signal.

FIG. 7 is a graph illustrating model predictions.

FIG. 8A illustrates a measured timing drift distribution.

FIG. 8B illustrates a simulated timing drift distribution.

FIG. 8C illustrates a simulated timing drift distribution.

FIG. 9 illustrates an embodiment of a computer system.

Like reference numerals refer to corresponding parts throughout the drawings.

### DETAILED DESCRIPTION OF EMBODIMENTS

In one embodiment of a supervised learning system and method for characterizing a circuit, described in more detail below, input parameters for the circuit are provided and a characteristic of the circuit is determined. A simulated output parameter of the circuit is determined using a supervised learning algorithm in accordance with the characteristic and at least two of the input parameters. In addition, a first pass/fail criterion is determined in accordance with the simulated output parameter.

The supervised learning system may be implemented, at least in part, using an artificial neural network. In some embodiments, the circuit being characterized is rejected if it fails to meet the first pass/fail criterion. In some embodiments, a measurement is performed on the circuit to determine a second pass/fail criterion if the circuit fails to meet the first pass/fail criterion.

In some embodiments, the supervised learning method is implemented in a tester, such as an integrated-circuit tester. In some embodiments, the supervised learning method is implemented in a self-test circuit that is included in the circuit. In some embodiments, the method is implemented, at least in part, in computer-aided design software.

In some embodiments, the supervised learning algorithm is trained using a data set that includes a training set of input parameters and a measured output parameter. The data set may correspond to an integrated circuit and/or to an integrated circuit lot. The integrated circuit lot includes integrated circuits fabricated on a common wafer or integrated circuits fabricated on a set of wafers.

An independent set of input parameters may be generated by performing principle component analysis on the set of input parameters. Performing principle component analysis can be applied to remove redundancies and correlation in the input parameters and to derive an new set of uncorrelated input parameters. The training set of input parameters may include a plurality of values of the input parameters. In some embodiments, the training set of input parameters includes an orthogonal array of values of the input parameters. In some embodiments, the set of input parameters includes a range of values for at least two of the input parameters.

A magnitude of the maximum and minimum values (sometimes called the extrema) of a respective parameter may be compared with a respective threshold. In various embodiments, this threshold corresponds to one, two, three or four standard deviations of the distribution corresponding to the respective parameter.

In some embodiments, determination of the simulated output parameter includes Monte Carlo analysis, and/or determination of the characteristic includes performing a measurement.

By utilizing the method, associated programs and/or systems, faster, lower cost and/or more accurate characterization and/or testing of one or more circuits and/or integrated circuits may be enabled. In this way, at least some of the aforementioned challenges associated with existing characterization of circuits and/or integrated circuits may be reduced and/or eliminated.

Reference will now be made in detail to embodiments, examples of which are illustrated in the accompanying drawings. In the following detailed description, numerous specific details are set forth in order to provide a thorough understanding of the subject matter presented herein. However, it will be apparent to one of ordinary skill in the art that the subject matter may be practiced without these specific details. In other instances, well-known methods, procedures, components, and circuits have not been described in detail so as not to unnecessarily obscure aspects of the embodiments.

Below, techniques for characterizing a circuit are described. In some embodiments, the circuit may be included in an integrated circuit. In these techniques, simulations, measurements, and/or specified operating parameters of the circuit are used as inputs in simulations of an output parameter of the circuit, and this output parameter is used to determine if the circuit fails to meet a pre-determined criterion, for example, if an error rate exceeds a pre-determined value. These simulations of the output parameter may use a supervised learning algorithm or technique, which may be implemented using support vector machines, classification and regression analysis, and/or an artificial neural network.

The supervised learning algorithm or technique may be trained using a data set that includes specified operating parameters of the circuit, measurements performed on the circuit and/or simulations of outputs from the circuit. In some embodiments, the data set may correspond to one or more lots of integrated circuits that are fabricated on a common wafer or on a set of wafers. These one or more lots of integrated circuits may or may not include the circuit being characterized.

If the circuit fails to meet the pre-determined criterion, the circuit may be rejected. Alternatively, in some embodiments, the output parameter may be measured if the circuit fails to meet the pre-determined criterion. The measured output parameter may be used to determine another pass/fail criterion for the circuit. Thus, the simulated output parameter may be used to accelerate characterization of the circuit for those output parameters that are difficult or time consuming to measure, and/or to screen the circuit to determine if such difficult or time consuming measurements are needed. For example, a small number of measurements of the output parameter(s) and the supervised learning technique may determine the mapping or relationship between one or more output parameters of the circuit and performance of the circuit (such as an error rate) allowing the model to generate realistic distributions and statistics for the performance of the circuit and/or a related system.

The characterization techniques described in this document may be implemented in a tester, in a self-test circuit (for example, in an integrated circuit that includes the circuit), and/or in computer-aided design software. In some embodiments, the computer-aided design software includes a transistor-level circuit simulator, such as Simulation Program with Integrated Circuits Emphasis (SPICE), PSPICE, and/or HSPICE. The transistor-level circuit simulator may include an Input/Output Buffer Information Specification (IBIS) compatible node list. In other embodiments, the computer-aided design software includes a behavioral synthesis circuit simulator, such as simulators that are compatible with Very High Speed Integrated Circuit Hardware Description Language (VHDL), simulators that are compatible with Verilog, simulators that are compatible with Register Transfer Logic (RTL), simulators that are compatible with a GDS II database format, simulators that are compatible with the MATLAB data-manipulation software package, simulators that are compatible with the C programming language, and/or simulators that are compatible with the C++ programming language.

The circuit may be an integrated circuit or semiconductor device, or other solid-state circuit device. The circuit may be a memory controller and/or a memory device. The memory device may include a memory core that utilizes solid-state memory, semiconductor memory, organic memory and/or another memory material, including volatile and/or non-volatile memory. The memory device may include dynamic random access memory (DRAM), static random access memory (SRAM) and/or electrically erasable programmable read-only memory (EEPROM). The circuit may be included in one or more components in a memory system, such as a memory controller and/or one or more memory devices. The one or more memory devices may be embedded in one or more memory modules. The memory controller and the one or more memory devices may be on a common or same circuit board. The circuit may be included in one or more components in other systems, such as those that include logic chips, a serializer/deserializer, PCI Express, other high-speed interfaces or input/output links, analog circuits, mixed signal circuits, and/or digital circuits.

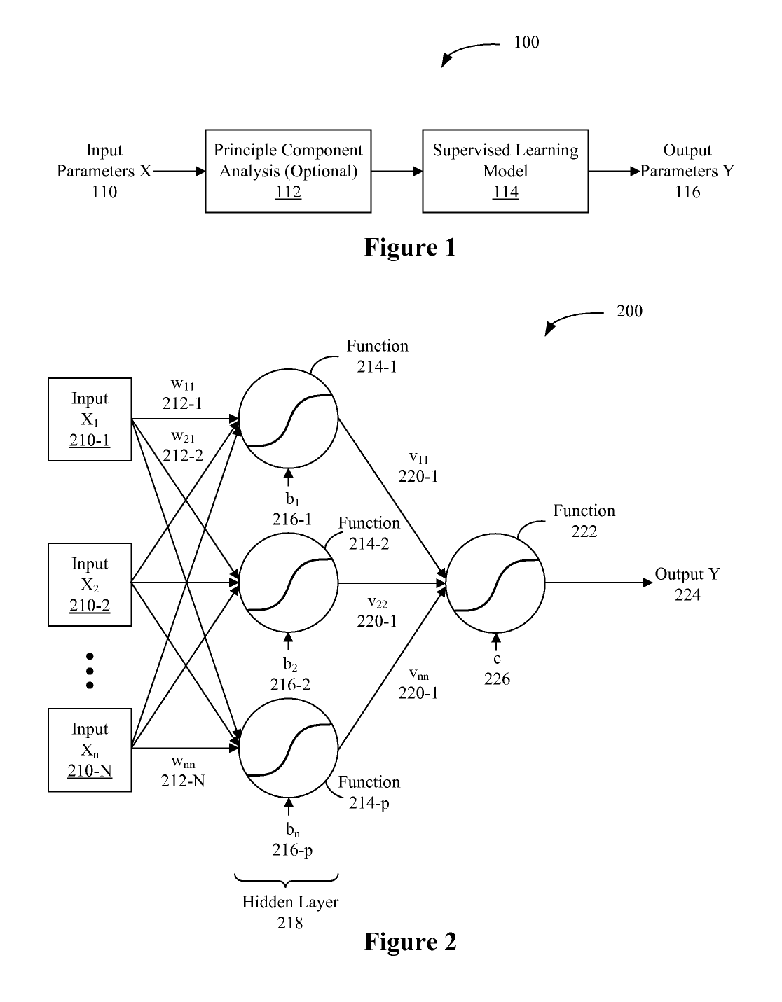

We now describe embodiments of the method for characterizing circuits. FIG. 1 is a block diagram illustrating an embodiment of a system 100 for modeling a device, such as the circuit. Input parameters X 110 are input to a supervised learning model 114, which determines output parameters Y 116. In some embodiments, Principle Component Analysis 112 is optionally performed on the input parameters X 110 to generate an independent set of input parameters prior to performing simulations using the supervised learning model 114. However, in other embodiments, correlations between some of the input parameters X 110 may be allowed.

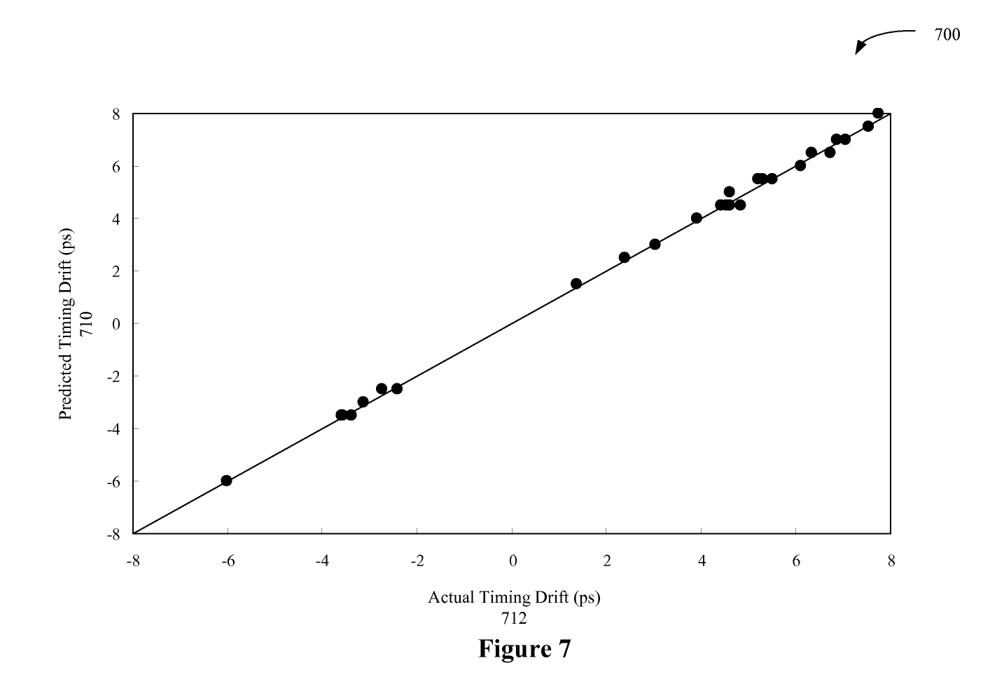

The input parameters X 110 may include operating parameters of the circuit, as well as simulated and/or measured output parameters from the circuit. Furthermore, the input parameters X 110 may include a plurality of values. For example, a range of values may be included for at least two of the input parameters X 110. Examples of a set of input parameters, such as the input parameters X 110, are described below with reference to FIG. 7.

In some embodiments, the input parameters X 110 include an orthogonal array of input parameter values that may be used as part of a design of experiments analysis. Such an orthogonal array ensures that all possible combinations in the array occur an equal number of times. Orthogonal arrays, therefore, may allow a parameter space to be studied without performing numerous measurements at small increments of parameter values. For example, in a 2-level orthogonal array (having entries such as 0 or 1) with three factors or parameters, there are three columns (corresponding to the three factors) and four rows (each corresponding to a particular experiment, i.e., a particular combination of values of the factors). Any two columns in this array are guaranteed to have all possible combinations of 0 and 1 (00, 01, 10 and 11) an equal number of times. The array in this example, therefore, has a strength of 2, and is denoted as L₄ (2³).

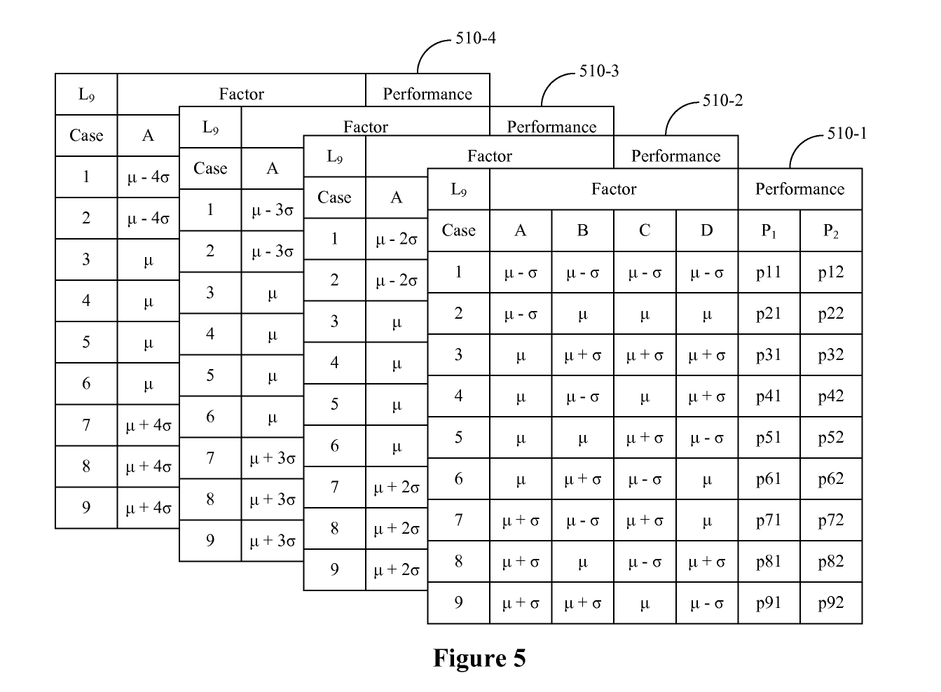

Another example of an orthogonal array is one with four factors or parameters having three levels or values (low, nominal, and high). This array is denoted as L₉ (3⁴), i.e., it has 4 columns, 9 rows and 3 levels. Note that in general, an orthogonal array may be denoted as Lₑₓₚₑᵣᵢₘₑₙₜₛ(levels^{factors})=Lₗₑᵥₑₗ_{^{m}}(level^{(level}^{^{m}}^{-1)/2}), where m may be determined from the number of factors. Examples of such orthogonal arrays are described below with reference to FIG. 5.

FIG. 2 is a block diagram illustrating a neural network model 200, which is also known as a multilayer perceptron model. This model provides a robust representation of the nonlinear mapping between input parameters Xᵢ 210 (in an input layer) and output Y 224, which may represent performance of the circuit. Weights Wᵢⱼ 212 are applied to the input parameters Xᵢ 210, which are coupled to input functions 214 at nodes in hidden layer 218. Additional weights bᵢ 216 are applied in the hidden layer 218 and weights vᵢⱼ 220 are applied to intermediate outputs from the hidden layer 218. A function 222 (such as a quadratic function) and weight c 226 are applied to these intermediate outputs at nodes in an output layer to produce the output Y 224. Mathematically, the neural network model 200 may be expressed as

$$Y = ϕ ( c + {\sum }_{j = 1}^{q} {v}_{j} {Ψ}_{j} ( {\sum }_{i = 1}^{p} {w}_{ij} {X}_{i} + {b}_{j} ) ) + ɛ ,$$

where X and Y are n-dimensional input and m-dimensional output vectors, respectively, Ψ and φ are activation functions at the nodes of the neural network, p and q are number of nodes in the hidden layer and output layer, respectively, and ε is the approximation error.

The neural network model 200 may efficiently approximate complex functions and relationships due to its nonlinear modeling and parallel processing capabilities, as well as its abilities to learn and generalize (so-called back propagation). In particular, since input-output relationships are expressed using simple functions, the neural network model 200 may be evaluated quickly while maintaining accuracy.

While neural network model 200 is illustrated as having a certain configuration of components, it should be understood that this illustration is conceptual. As such, in other embodiments there may be fewer or additional components (such as additional hidden layers or functions), two or more components may be combined into a single component, and a position of one or more components may be changed.

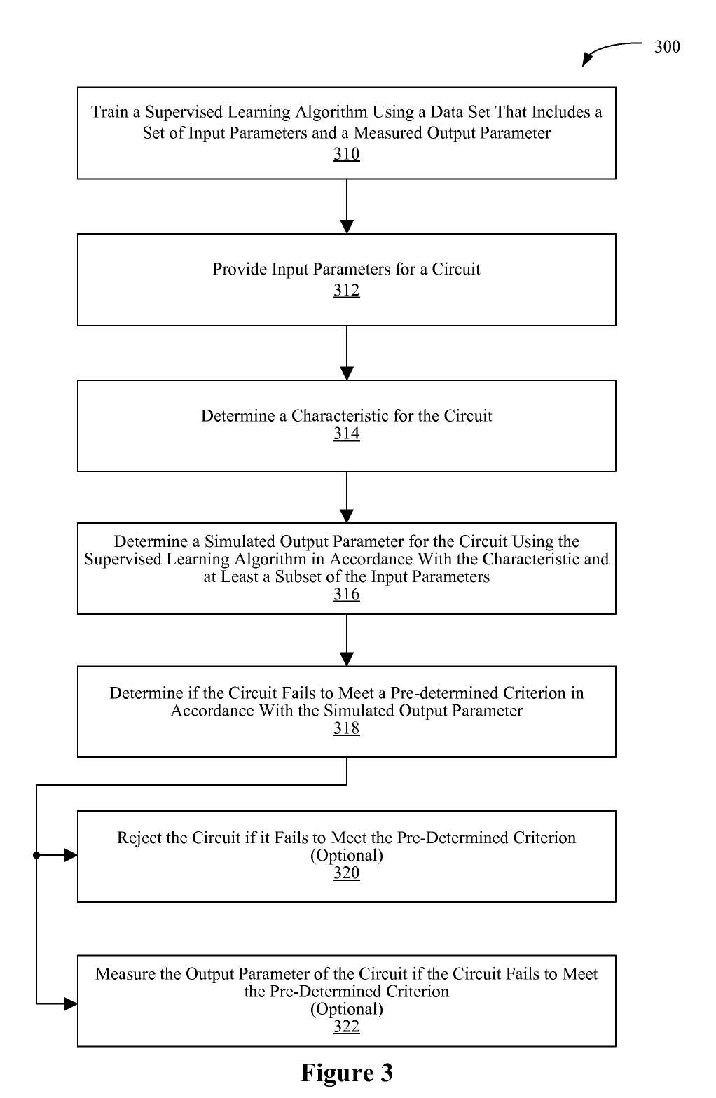

FIG. 3 is a flow diagram illustrating an embodiment of a method 300 for characterizing a circuit. A supervised learning algorithm is trained using a data set that includes a set of input parameters and a measured output parameter (310). In other embodiments, the supervised learning algorithm is already trained. Input parameters for a circuit are provided (312). As discussed elsewhere in this document, the input parameters used for training the supervised learning algorithm may include an orthogonal array of values of the input parameters. A characteristic for the circuit is determined (314). For example, the characteristic may be determined by performing one or more measurements of the circuit's characteristic. In some cases, the characteristic may be one that requires a large number of time consuming measurements. For instance, the characteristic may be a voltage or current gain, a timing margin, a phase margin, a voltage margin, a maximum or minimum operating frequency, voltage or other circuit performance parameter, or the like. A simulated output parameter for the circuit is determined using the supervised learning algorithm in accordance with the characteristic and at least two of the input parameters (316). For example, measured values of the two or more input parameters for a specific instance of the circuit may be processed by the supervised learning algorithm to produce a simulated output parameter, which in turn corresponds to the characteristic of the circuit discussed above. A determination is made as to whether the circuit (i.e., the specific instance of the circuit for which the input parameters were processed by the supervised learning algorithm) fails to meet a pre-determined criterion in accordance with the simulated output parameter (318). If the circuit fails to meet the pre-determined criterion, the circuit may be rejected (320). Alternatively, if the circuit fails to meet the pre-determined criterion, the output parameter of the circuit may be measured (322), and the results of the measurement may be used to determine if the circuit passes or fails another pre-determined criterion. For example, if the value of the simulated output parameter falls within a predefined range, additional testing of the circuit may be required to determine if the circuit passes or fails a second criterion (e.g., whether or not the circuit functions in accordance with a predefined specification).

In an exemplary embodiment of the method 300, parameters and desired performance(s) (the pre-determined criterion) of the circuit are identified. The parameters may include associated tolerances. Using the range and number of parameters, an orthogonal array is defined. Measurements are performed on the circuit to determine the characteristic. These measurements are performed using defined values of the parameters.

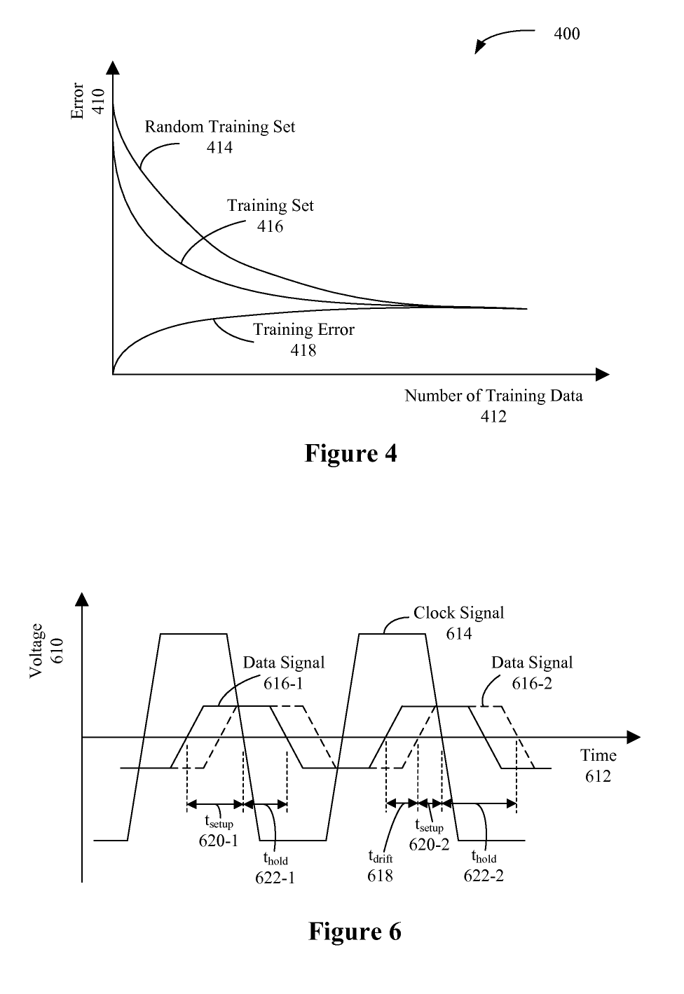

As described further below with reference to FIG. 4, training and test sets of data are prepared and used to train and validate the supervised learning model. Preparing these data sets may include normalizing input and output parameters. The input-output training parameters are scaled to provide balance among different input output values that may be different orders of magnitude. For example, impedance parameters can range between 50 and 100 Ohms, current values can range in several milliamps, capacitance values and rise/fall times can range in picofarads and picoseconds, respectively. This systematic preprocessing is important in order to remove the vast differences in parameter values and guaranteeing convergence. In some embodiments, the input parameters are normalized so that the average and maximum allowed deviations are set to zero and one, respectively. The output is also normalized with the minimum and maximum to −1 and 1, respectively. In embodiments where the supervised learning model is a neural network, training may include techniques such as back propagation.

The validated model may be used to generate distributions and statistics for the output parameter. For example, in some embodiments, Monte Carlo analysis may be performed using a neural network that implements the validated model of the circuit. Based on the distribution and statistics, performance and yield for the circuit may be predicted.

In some embodiments, there may be fewer or additional operations, an order of the operations may be rearranged and/or two or more operations may be combined. In some embodiments, the method 300 may be implemented, at least in part, using a computer and/or a circuit.

FIG. 4 is an exemplary graph 400 that illustrates error as a function of model training. In particular, error 410 is shown as a function of a number of training data 412. As the number of training data 412 increases, the error between model predictions and a training set 416 decreases and the error between the model predictions and a test set 418 increases. In essence, more data or more complexity in the model allows for better prediction of the training set 416. However, as overfitting occurs, the model may predict features in the training set 416 that are not global. As a consequence, the error for the test set 418 increases. The effect of overfitting is also illustrated by the use of a random training set 414. When the model is able to predict the random training set 414, the model is in essence able to predict random noise. Thus, exemplary graph 400 illustrates the need to optimally determine the model complexity and the size of the training data in order to make accurate predictions without overfitting. Examples of the amount of model complexity and the size of the training data set are described below with reference to FIGS. 5-8.

We now discuss exemplary embodiments of the method for characterizing circuits. In one embodiment, the technique may be used to characterize timing drift of a multi-GHz chip-to-chip communication circuit over a range of supply voltages and temperature. The input parameters in this example include three supply voltages (V_{DDC}, V_{DDA}, and Vterm or the termination voltage) of the circuit and temperature. This is an example of system level characterization of a circuit. In other embodiments, the method of characterizing a circuit may be used at various circuit levels, for example the sub-component level, the component level (chip level), and/or the system level. The circuit parameters to be monitored may vary depending on the circuit level begin characterized. For example, during the testing of an individual circuit, parameters such as voltages, currents, temperature, and capacitance (among others) may be measured. When the circuit under test is to be characterized at the subcomponent level, examples of input parameters to be measured include input impedance, I/O node capacitance, waveform rise time or fall time, voltage at one or more particular circuit nodes, current along one or more particular circuits paths, and so on. The measured parameter values are then processed by the trained model (e.g., the supervised training algorithm) to obtain a predicted output value for a characteristic of the circuit under test that would otherwise be much more time consuming to evaluate. Examples of such circuit characteristics are provided above.

Alternately, or in addition, a Monte Carlo analysis may be performed using the trained model or supervised training algorithm, generating simulated outputs for a randomly or pseudo-randomly generated set of input parameters. The resulting distribution of output values may be used to predict a pass/fail yield for the circuit and/or to identify faults or potential faults in the design of the circuit corresponding to the trained model or supervised training algorithm.

FIG. 6 is a timing diagram illustrating setup, hold and drift timing parameters. Voltage 610 of signals is shown as a function of time 612. The signals include clock signal 614 and data signals 616-1, 616-2. Due to timing drift t_{drift} 618, there is a variation in setup times tₛₑₜᵤₚ 620 (620-1, 620-2) and hold times t_{hold} 622 (622-1, 622-2), which may be referenced to the falling edge of the clock signal 614. Note that t_{drift} 618=(t_{hold} 622-2−tₛₑₜᵤₚ 620-2)/2−(t_{hold} 622-1−tₛₑₜᵤₚ 620-1)/2.

Measurements of the setup times tₛₑₜᵤₚ 620 and hold times t_{hold} 622 were performed for various voltage and temperature values. Using this data, the timing drift t_{drift} 618 was determined. In this way, a total of 108 values of the timing drift t_{drift} 618 were obtained. Eighty-one of these values and the corresponding voltages and temperatures were used to train the neural network. The resulting neural network includes four nodes in the input layer, five nodes in the hidden layer and one node in the output layer.

FIG. 7 illustrates a graph 700 that compares predicted timing drift 710 and actual (measured) timing drift 712 from the test data set. Note that the error between the predicted timing drift from the model and the test data set is 100 fs, and the corresponding error with respect to the training data set is 20 fs.

Referring to FIG. 5, using selected timing measurements, parameter settings (voltages and temperatures) and additional measurements of performance of the communication circuit (such as an error rate), orthogonal arrays 510-1 to 510-4 were defined. These arrays selectively and thoroughly probe the distributions of the parameters and performance without resorting to an exhaustive number of combinations, which is often impractical. In this example, three-level orthogonal arrays were used. In a given array, the three levels include the mean minus a number n of standard deviations (μ−nσ), the mean (μ), and the mean plus the number n of standard deviations (μ+nσ), where n is 1, 2, 3 or 4. Since there are four factors each having three levels, L₉ arrays were used. Note that in addition to the four factors, two simulated performance parameters are also included. In other embodiments, fewer or additional orthogonal arrays are used.

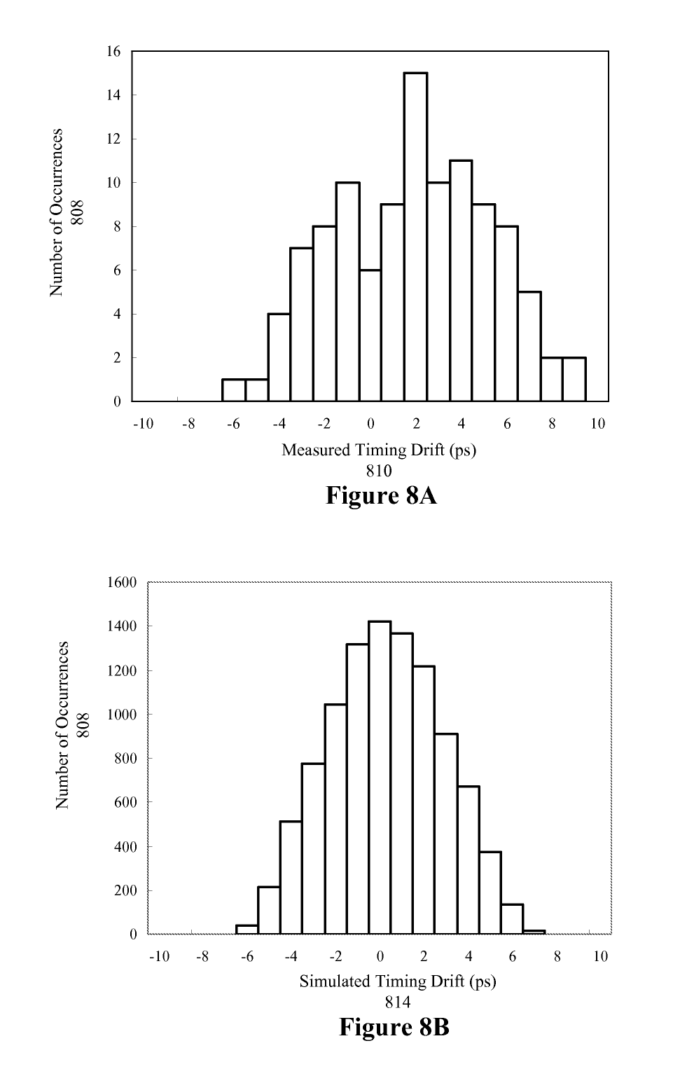

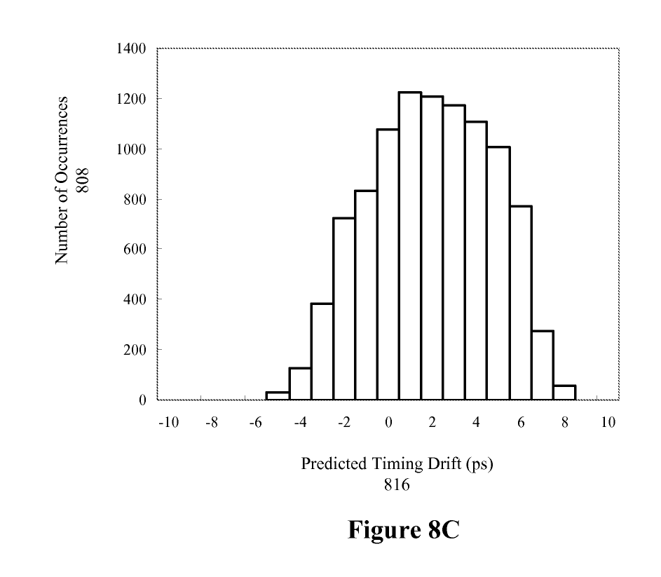

Comparisons of histograms of a number of occurrences 808 of measured timing drift 810 and simulated timing drift 814 (using the neural network model and the orthogonal arrays) are provided in FIGS. 8A and 8B. In addition, predicted timing drift 816 for a regression model is provided in FIG. 8C. This regression model includes a linear relationship between the predicted timing drift 816 and the voltages and temperature.

While the histograms from the neural network model and the regression model have smaller standard deviations than the measurements, the regression model results have significantly different mean, median, mode and asymmetry relative to the measurements and the neural network model results. These differences are summarized in Table I.

TABLE I
Statistics for measured and simulated timing drift.

| | Measurements | Neural Network | Regression |
|---|---|---|---|
| Mean | 1.54 | 1.65 | −0.22 |
| Standard Error | 0.33 | 0.03 | 0.03 |
| Median | 1.50 | 1.72 | −0.22 |
| Mode | 1.50 | 1.02 | −0.01 |
| Standard Deviation | 3.39 | 2.65 | 2.56 |
| Sample Variance | 11.51 | 7.02 | 6.56 |
| Kurtosis | −0.69 | −0.65 | −0.60 |
| Skewness | −0.07 | −0.03 | 0.01 |
| Range | 14.50 | 14.33 | 13.23 |
| Minimum | −6.0 | −5.81 | −6.86 |
| Maximum | 8.50 | 8.52 | 6.37 |

Therefore, compared with the regression model statistics, the neural network results in FIG. 8B offer a reasonable approximation to the distribution and the statistics of the timing drift over a range of voltages and temperatures. Simulated distributions of this and other output parameters from the circuit may be used to efficiently predict performance and yield of the circuit. Such characterization may be utilized during the design process and/or during testing of the circuits.

In another exemplary embodiment, the method for characterizing a circuit is used to characterize performance of an interconnect. Factors in this example, include a printed circuit board impedance, a package impedance, a termination value, and the current. Once again, orthogonal arrays may include three levels, such as the mean minus a number n of standard deviations (μ−nσ), the mean (μ), and the mean plus the number n of standard deviations (μ+nσ), where n is 1, 2, 3 or 4. The orthogonal arrays may also include simulated or measured output parameters from the interconnect, such as a voltage margin (eye height) and timing margin (or jitter). After training and validating the supervised learning model, the model may be used to generate distributions and statistics of desired factors and/or performance metrics. These results may be used to characterize the interconnect, for example, to determine if it meets a pass/fail criterion or if additional testing is needed.

Devices and circuits described herein can be implemented using computer aided design tools available in the art, and embodied by computer readable files containing software descriptions of such circuits, at behavioral, register transfer, logic component, transistor and layout geometry level descriptions stored on storage media or communicated by carrier waves. Data formats in which such descriptions can be implemented include, but are not limited to, formats supporting behavioral languages like C, formats supporting register transfer level RTL languages like Verilog and VHDL, and formats supporting geometry description languages like GDSII, GDSIII, GDSIV, CIF, MEBES and other suitable formats and languages. Data transfers of such files on machine readable media including carrier waves can be done electronically over the diverse media on the Internet or through email, for example. Physical files can be implemented on machine readable media such as 4 mm magnetic tape, 8 mm magnetic tape, 3½ inch floppy media, CDs, DVDs and so on.

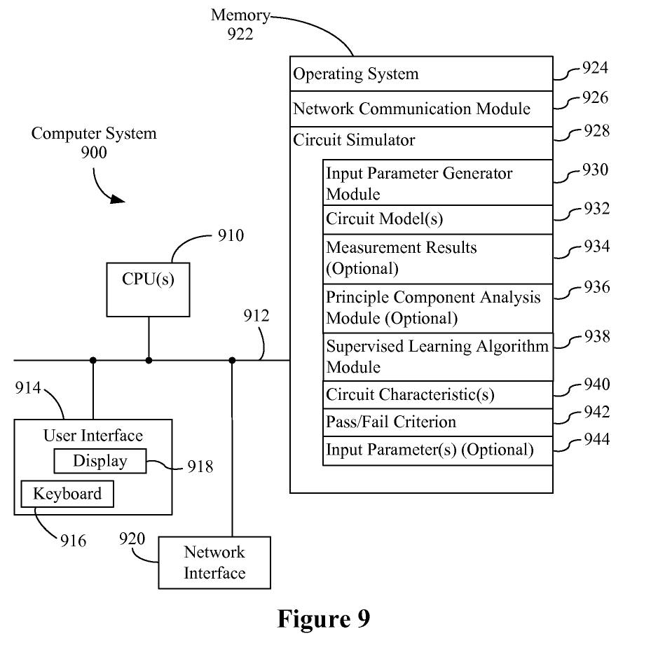

We now discuss embodiments of systems that may implement the method for characterizing a circuit. FIG. 9 illustrates an embodiment of a computer system 900. The system 900 may include at least one data processor or central processing unit (CPU) 910, memory 922, a user interface 914 for accepting user input or commands and providing results to the user, a network interface 920 for coupling the computer system 900 to one or more remotely located computers and/or data structures, and one or more signal lines or communication buses 912 for coupling these components to one another. The communication buses 912 may include circuitry (sometimes called a chipset) that interconnects and controls communications between system components. The user interface 914 may include a display 918, a keyboard 916 and/or a pointer device (not shown), such as a mouse.

Memory 922 may include high-speed random access memory and/or non-volatile memory, such as one or more magnetic disk storage devices. Memory 922 may store an operating system 924, such as LINUX, UNIX, OS X or WINDOWS, that includes procedures (or a set of instructions) for handling basic system services and for performing hardware dependent tasks. The memory 922 may also store communication procedures (or a set of instructions) in a network communication module 926. The communication procedures are used for communicating with clients and/or with other servers and computers.

Memory 922 may store a circuit simulator 928 (or a set of instructions) for simulating and/or determining the output parameter from the circuit and determining if the circuit meets the pre-determined pass/fail criterion. The circuit simulator 928 may include an input parameter generator module 930, circuit model(s) 932, optional measurement results 934, optional principle component analysis module 936, supervised learning algorithm module 938, circuit characteristic(s) 940, pass/fail criterion 942 and optional input parameters 944. The modules and data in the circuit simulator 928 may be used to generate one or more orthogonal arrays (which include input parameters, measurements and/or simulations) to determine distributions for the output parameter from the circuit. These results may be used to determine if the circuit meets a pass/fail criterion, such as the pass/fail criterion 942, and/or additional testing/characterization of the circuit is needed.

The foregoing descriptions of specific embodiments of the present invention are presented for purposes of illustration and description. They are not intended to be exhaustive or to limit the invention to the precise forms disclosed. Rather, it should be appreciated that many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method for characterizing a circuit, comprising:
providing input parameters for the circuit;
determining a characteristic of the circuit;
determining a simulated output parameter of the circuit using a supervised learning algorithm in accordance with the characteristic and at least two of the input parameters; and
determining a first pass/fail criterion in accordance with the simulated output parameter.

2. The method of claim 1, further comprising rejecting the circuit if it fails to meet the first pass/fail criterion.

3. The method of claim 1, further comprising performing a measurement on the circuit to determine a second pass/fail criterion if the circuit fails to meet the first pass/fail criterion.

4. The method of claim 1, wherein the method is implemented in a tester.

5. The method of claim 1, wherein the method is implemented in a self-test circuit that is included in the circuit.

6. The method of claim 1, wherein the method is implemented in computer-aided design software.

7. The method of claim 1, wherein the supervised learning algorithm is implemented, at least in part, using an artificial neural network.

8. The method of claim 1, further comprising training the supervised learning algorithm using a data set that includes a training set of input parameters and a measured output parameter.

9. The method of claim 8, wherein the data set corresponds to an integrated circuit.

10. The method of claim 8, wherein the data set corresponds to an integrated circuit lot, and wherein the integrated circuit lot includes integrated circuits fabricated on a common wafer.

11. The method of claim 8, wherein the data set corresponds to an integrated circuit lot, and wherein the integrated circuit includes integrated circuits fabricated on a set of wafers.

12. The method of claim 8, further comprising generating an independent set of input parameters by performing principle component analysis on the set of input parameters.

13. The method of claim 8, wherein the training set of input parameters includes a plurality of values of the input parameters.

14. The method of claim 8, wherein the training set of input parameters includes an orthogonal array of values of the input parameters.

15. The method of claim 13, wherein the training set of input parameters includes range of values for at least two of the parameters in the training set of input parameters.

16. The method of claim 15, wherein a magnitude of extrema for a respective range in the range of values corresponding to a respective parameter is less than a respective threshold, and wherein the respective threshold is selected from the group consisting of one standard deviation for a distribution corresponding to the respective parameter, two standard deviations for a distribution corresponding to the respective parameter, three standard deviations for a distribution corresponding to the respective parameter, and four standard deviations for a distribution corresponding to the respective parameter.

17. The method of claim 1, wherein determining a simulated output parameter includes performing Monte Carlo analysis using the supervised learning algorithm to generate distributions and statistics for the output parameter.

18. The method of claim 1, wherein determining the characteristic includes performing a measurement.

19. A computer program product, for use in conjunction with a computer system, the computer program product comprising:
instructions for providing input parameters for the circuit;
instructions for measuring a characteristic of the circuit;
instructions for determining a simulated output parameter from the circuit using a supervised learning algorithm in accordance with the characteristic and at least two of the input parameters; and
instructions for a first pass/fail criterion in accordance with the simulated output parameter.

20. A system, comprising:
one or more central processing units to execute programs;
memory; and
a program, stored in the memory and executed by the processor, the program including:
instructions for providing input parameters for the circuit;
instructions for measuring a characteristic of the circuit;
instructions for determining a simulated output parameter from the circuit using a supervised learning algorithm in accordance with the characteristic and at least two of the input parameters; and
instructions for a first pass/fail criterion in accordance with the simulated output parameter.

21. A system, comprising:
processing means for executing programs;
memory; and
a program, stored in the memory and executed by the processor, the program including:
instructions for providing input parameters for the circuit;
instructions for measuring a characteristic of the circuit;
instructions for determining a simulated output parameter from the circuit using a supervised learning algorithm in accordance with the characteristic and at least two of the input parameters; and
instructions for a first pass/fail criterion in accordance with the simulated output parameter.
